(19) United States
(12) Patent Application Publication
(10) Pub. No.: US 2007/0159311 A1
(43) Pub. Date: Jul. 12, 2007

(54) Vehicle separation warning device

(76) Inventor: Scott Schober, Dandridge, TN (US)

Correspondence Address: SCOTT SCHOBER, PO Box 1592, Dandridge, TN, 37725, US

(21) Appl. No.: 11/326,757

(22) Filed: Jan. 6, 2006

(51) Int. Cl. B60Q 1/00

(52) U.S. Cl. 340/435

(57) ABSTRACT

A method and apparatus for providing warnings related to vehicle separation. The warning device of the invention generally includes a distance measuring sensor positioned on a rearward facing surface of a first vehicle, the distance measuring sensor being configured to measure a distance between the first vehicle and a second vehicle following the first vehicle, a microprocessor controller in electrical communication with the distance measuring sensor and being configured receive input from the distance measuring sensor and generate outputs therefrom, and a visual warning device positioned on the first vehicle and being in electrical communication with the microprocessor controller. Generally, the controller of the device is configured to execute a program configured to conduct a method, wherein the method includes: a) receiving a distance measurement in the controller from the distance measuring sensor, wherein the distance measurement is representative of the distance from the rear of the first vehicle to the front of the second vehicle; b) determining if the distance measurement is within one of a plurality of predetermined safety zone thresholds; and c) illuminating the visual warning device in accordance with the determined predetermined safety zone thresholds.

### BACKGROUND OF THE INVENTION

1. Field of the Invention

Embodiments of the invention generally relate to an apparatus and method for alerting a driver of a vehicle to dangerous conditions so that the driver of the vehicle may take corrective action.

2. Description of the Related Art

The present invention relates to a distance separation system for vehicles. The invention has particular applicability to passenger cars, taxis, trucks, buses, and may be applied to water craft, aircraft, and other types of transportation mediums and military vehicle and motorized weapon systems as well. It is to be noted, however, that although the present invention is described below with respect to a vehicle in general, the invention is not intended to be limited to any particular vehicle. Rather, the present invention is contemplated as being applicable to all types and sizes of vehicles.

The most common cause of vehicle collisions is the failure of vehicle operators to maintain an adequate separation distance from other vehicles. Safe separation distance generally includes forward/backward separation between vehicles. The safe separation distance required to prevent front/rear-end type collisions generally depends on the reaction time of the vehicle driver, i.e., how long it takes the driver to process information that is indicative of an impending collision and to react by either applying the brakes of the vehicle or steering the vehicle away from the impact, the braking distance traversed by the vehicle before it comes to a stop or starts to decelerate faster than the vehicle it is likely to contact, and/or the difference in the deceleration rates between the two colliding vehicles, i.e., if the forward-most vehicle is decelerating faster than the rearward vehicle, then a collision is more likely as a result of the inherent decreasing separation distance. Each of the above noted factors may vary according to the surrounding conditions at the time of driving.

U.S. Pat. No. 3,681,750 to Larka (1972) discloses a passive device which detects ultrasonic signals; however, this device merely detects the presence of moving objects and does not inform the operator of the distance to these objects nor of their velocity, relative to the vehicle. Several types of ultrasonic collision avoidance systems have been proposed in, for example, U.S. Pat. No. 3,802,397 to Sindle (1974), U.S. Pat. No. 4,240,152 to Duncan and Wiley (1980), U.S. Pat. No. 4,260,980 to Bates (1981), U.S. Pat. No. 4,442,512 to Sigeeyuki and Akite (1980), U.S. Pat. No. 4,450,430 to Barishpolsky (1980), U.S. Pat. No. 4,626,850 to Chey (1986), and U.S. Pat. No. 4,694,295 to Miller and Pitton (1987). All of these systems have certain factors in common. For example, all of these inventions generally require numerous transducers along with associated circuitry to scan pertinent areas surrounding the vehicle. This greatly increases the cost of the system. Also, use of multiple transducers increases the complexity of the system, thereby decreasing dependability. All of these inventions also generally utilize transducers mounted in a way that the emitted ultrasonic signal is perpendicular to the vehicle. This arrangement does not make effective use of the natural shape of the signal since, at very close distances, the width of the signal is very narrow as opposed to having a much larger width at greater distances.

As a consequence of this arrangement, multiple transducers are needed in order to scan the entire side of the vehicle. Further, all of the above noted inventions generally require separate mountings for each transducer to scan an individual area. Transducers which are located at different points on the vehicle require excessive lengths of cable to interconnect and coordinate their activities, creating logistical and design problems. All of the noted inventions are also generally unable to differentiate between a stationary object and one that is moving. Stationary objects create false warnings which hinder rather than assist the operator. Their operation merely warns of objects when they are detected within a certain fixed distance. They do not compensate for varying vehicle speeds, which necessarily dictate a greater warning distance. All of the inventions are also unable to compensate for the addition of a trailer which would effectively void any protection provided by the system since any object located adjacent the trailer would go undetected. Also, the trailer itself would cause a false warning since the transducer used to scan the rear area, if provided, would detect the reflected ultrasonic signal from the trailer. All of the above noted inventions also utilize dedicated electrical circuits which do not allow for an operator to program in preferred warning distances.

Although there are many anti-collision systems available in the art, none of the conventional systems have the novel features of the present invention. For example, the present invention provides spatial monitoring for the front and back of the vehicle. However, unlike the conventional separation devices, the present invention is designed to warn other drivers (even those who may not have any sort of separation device installed on their vehicle) of an impending collision. The present invention also provides the user the ability to program the minimum safe distance, along with parameters that contribute to the minimum safe distance, such as ambient conditions, vehicle parameters, etc. The present invention also provides multiple levels of warnings, e.g., a normal warning when spatial separation has been compromised and an urgent warning when spatial separation has been compromised and impact is likely without immediate action. The present invention also has the unique capability of communicating with like devices in other invention equipped vehicles, e.g., adjustments for vehicle size, weight, and type can be instantly communicated between vehicles and factored into the algorithms used to predict safe stopping and spatial separation distances.

Embodiments of the invention address the challenges presented above.

### SUMMARY OF THE INVENTION

The present invention generally relates to a vehicle separation apparatus that is configured to alert the drivers of “other” vehicles of unsafe conditions or an impending collision. The system generally includes a distance sensor that is positioned on a vehicle in a location that allows the sensor to determine the distance between the vehicle and another vehicle. A display device is positioned on the vehicle in a configuration that allows drivers of “other” vehicles to see the display, primarily when the cars are behind the vehicle having the display mounted thereon. The system further includes a microprocessor controller configured to control the operation of the sensors and the display device. A dash mounted display/control unit allows the driver of the invention equipped vehicle to input driving conditions and other variables as well as have an LED display that indicates spatial separation.

Embodiments of the invention generally provide a vehicle separation warning device. The warning device of the invention generally includes a distance measuring sensor positioned on a rearward facing surface of a first vehicle, the distance measuring sensor being configured to measure a distance between the first vehicle and a second vehicle following the first vehicle, a microprocessor controller in electrical communication with the distance measuring sensor and being configured to receive input from the distance measuring sensor and generate outputs therefrom, and visual warning devices positioned on the first vehicle and being in electrical communication with the microprocessor controller. Generally, the controller of the devices is configured to execute a program configured to conduct a method, wherein the method includes: a) receiving a distance measurement in the controller from the distance measuring sensor, wherein the distance measurement is representative of the distance from the rear of the first vehicle to the front of the second vehicle; b) determining if the distance measurement is within one of a plurality of predetermined safety zone thresholds; and c) illuminating the visual warning devices in accordance with the determined predetermined safety zone thresholds. In the case of a warning device installed on heavy commercial or governmental vehicles data store media can record instances of tailgating, length and duration, etc for the purposes of documenting safe driving records.

Embodiments of the invention may further provide a method for warning tailgating vehicles of unsafe following distances. The method generally includes measuring a distance from a first vehicle to a second vehicle with a distance sensor positioned on a rearwardly facing surface of the first vehicle, transmitting the measured distance to a microprocessor controller positioned in the first vehicle, comparing, with the controller, the measured distance to stored safe zone distances to determine if the distance corresponds to a predetermined safe zone, and illuminating a visual display panel positioned on the rearwardly facing surface of the first vehicle and the dash mounted unit in a manner corresponding to the determined predetermined safe zone.

Embodiments of the invention may further provide a vehicle separation warning device. The separation device generally includes a Doppler distance measuring sensor positioned on a rearward facing surface of a first vehicle, the Doppler distance measuring sensor being configured to measure a distance between the first vehicle and a second vehicle following the first vehicle, a microprocessor controller in electrical communication with the distance measuring sensor and being configured receive input from the distance measuring sensor and generate outputs therefrom in accordance with an assembly language program, and visual warning devices positioned on the first vehicle and being in electrical communication with the microprocessor controller, the visual warning device including a plurality of multiple color LEDs. The controller is configured execute a program configured to conduct a method that includes; a) receiving a distance measurement in the controller from the Doppler distance measuring sensor, wherein the distance measurement is representative of the distance from the rear of the first vehicle to the front of the second vehicle; b) determining if the distance measurement is within one of a plurality of predetermined safety zone thresholds; c) illuminating a particular color LED on the visual warning devices in accordance with the determined predetermined safety zone thresholds; and d) repeating steps (a)-(c) between about 200 and about 1000 times per second.

Embodiments of the invention may further provide a vehicle separation warning device. Each microprocessor contains certain vehicle specific data including but not limited to vehicle type, vehicle weight, vehicle make and model etc. This information is transmitted to other microprocessors in nearby vehicles via radio type broadcast. These transmissions are also utilized to measure distance between the first vehicle and a second vehicle following the first vehicle, a microprocessor controller in electrical communication with the receiver and being configured to receive input from the radio broadcast and generate outputs therefrom in accordance with an assembly language program, and a visual warning devices positioned on the first vehicle and being in electrical communication with the microprocessor controller, the visual warning devices including a plurality of multiple color LEDs. The controller is configured execute a program configured to conduct a method that includes; a) receiving a distance measurement in the controller from the broadcast signals, wherein the distance measurement is representative of the distance from the rear of the first vehicle to the front of the second vehicle; b) determining if the distance measurement is within one of a plurality of predetermined safety zone thresholds; c) illuminating a particular color LED on the visual warning devices in accordance with the determined predetermined safety zone thresholds; and d) repeating steps (a)-(c) between about 200 and about 1000 times per second. Additionally, data including all manner of vehicle specific information is read and stored in the microprocessor for two purposes. First, vehicle type and weight modify algorithms computing safe following distances. Second, unsafe driving, i.e., tailgating, instances are stored in terms of severity and duration and may be used to evaluate driving habits via downloading to external hardware and software. Additionally, once speed limit signs along roads and highways broadcast speed limits using radio type transmissions the microprocessor controller will keep driver notified of their speed in relation to the posted speed limit. Instances of speeding infractions may also be stored in the microprocessor for later download into external hardware and software.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates general layout of an operational embodiment of the spatial separation apparatus 100 of the invention

FIG. 2 illustrates a basic electrical schematic of an embodiment of the invention.

### DETAILED DESCRIPTION

An automobile device which will signal a following vehicle that the separation distance between it and the VSID equipped (occupied) vehicle is either safe (green), becoming unsafe(yellow), hazardous (red) or collision imminent (blinking red). VSID (pronounced V-Sid) utilizes a Doppler Radar Speed Sensor to determine speed and distance of a following vehicle and based upon programmed algorithms notifies the following driver (as well as the occupied vehicles driver on a dashboard display) via a light display (tail light integrated or stand alone) information about safe following distance.

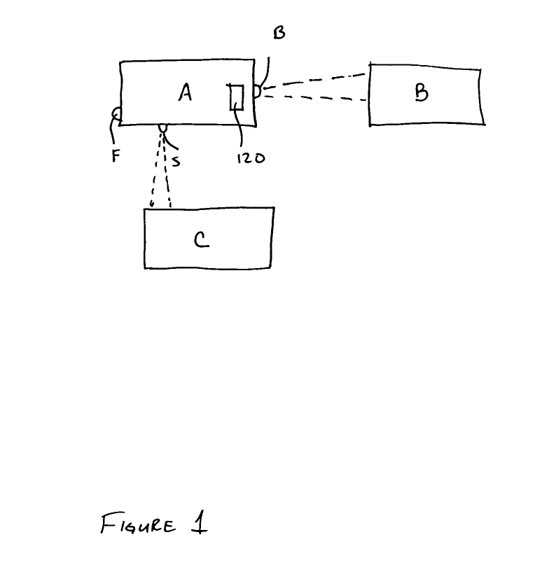

FIG. 1 illustrates general layout of an operational embodiment of the spatial separation apparatus 100 of the invention. The spatial separation apparatus 100 of the invention is illustrated as being positioned in vehicle A, and is operating to monitor and warn the drivers of vehicle B and C as to the spatial separation of vehicle B and vehicle C relative to vehicle A. The spatial separation apparatus 100 generally includes at least one of a plurality of signal emitters/receivers F, S, B that are in communication with a system controller 110, that is also in communication with a display device 120. The emitters/receivers may be ultrasonic, radio, sonar, infrared, radar, or other type of sensor that is capable of making distance measurements at distances of up to 250 feet.

The signal emitters/receivers F, S, B generally comprise devices capable of emitting a signal that may be used to measure the distance between the respective signal emitter and another object positioned proximate the signal emitter. Generally, the process of determining the distance from the respective emitter to the proximate object includes sending at least one signal from the emitter and determining the amount of time it takes for the signal to travel to the proximate object, bounce off of the object, and return to the emitter for collection by a signal receiver that may be integrally formed into the signal emitter.

Since the propagation speed of the signal from the emitter is generally a known parameter, Newtonian physical principles may be used to determine the distance the object (the other vehicles in the case of the present invention) is from the emitter, i.e., the distance a first object is from another object in this situation may be calculated as the propagation speed of the signal multiplied by the time the signal takes to traverse the distance between the emitter and the object.

The emitters/receivers F, S, B generally represent a front side vehicle emitter/receiver (F), a backside or rearward facing vehicle emitter/receiver (B), and at least one vehicle side emitter/receiver (S). The emitters/receivers F, S, B may generally operate on radar technology, i.e., the emitter may comprise a Doppler Radar sensor head (DRS). The emitters may alternatively be based upon optical signal technology, e.g., the emitters/receivers F, S, B may emit an optical signal, such as a laser light signal, that has a known wavelength and/or propagation speed that may be reflected off of the other vehicles B and C and subsequently received by the respective emitter/receiver. The emitters/receivers F, S, B may also generally operate on radio signal technology, e.g., the emitters/receivers F, S, B may emit a radio frequency signal that has a known wavelength and/or propagation speed that may be reflected off of the other vehicles B and C and subsequently received by the respective emitter/receiver. The emitters/receivers F, S, B may also generally operate on broadcast signal technology, e.g., the emitters/receivers F, S, B may emit a broadcast signal that contains pertinent vehicle data and also has a known wavelength and/or propagation speed that may be received from the other vehicles B and C and subsequently received by the respective emitter/receiver. The emitters/receivers F, S, B may also generally operate on acoustic signal technology, e.g., the emitters/receivers F, S, B may emit an acoustic signal that has a known wavelength and/or propagation speed that may be reflected off of the other vehicles B and C and subsequently received by the respective emitter/receiver. The emitters/receivers F, S, B may also generally operate on ultrasonic signal technology, e.g., the emitters/receivers F, S, B may emit an ultrasonic signal that has a known wavelength and/or propagation speed that may be reflected off of the other vehicles B and C and subsequently received by the respective emitter/receiver.

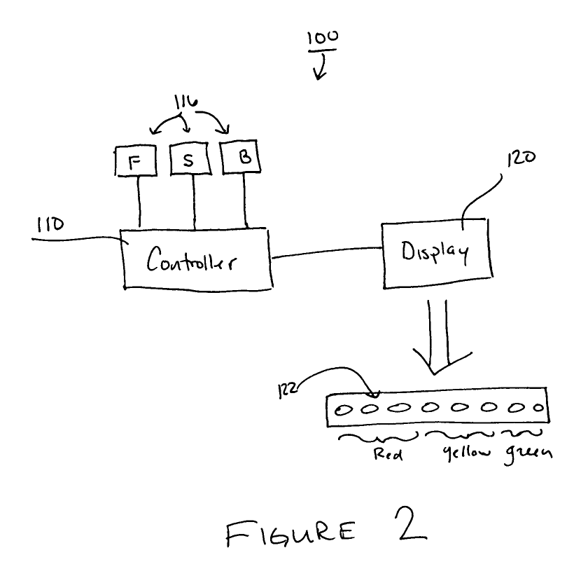

FIG. 2 illustrates a basic electrical schematic of an embodiment of the invention. Regardless of the particular emitter/receiver configuration used, the spatial separation apparatus 100 generally utilizes a controller 110 to control the operation of the emitters/receivers F, S, B. The controller 110 may be a microprocessor-type controller configured to receive inputs from a user or other sensors in communication with the controller 110, process the inputs in accordance with at least one predetermined control algorithm, and generate control signals in accordance with the control algorithm. Other exemplary controller configurations include programmable devices such as various, general hard wired control circuits, and existing controllers that are already present in the vehicle that may be leached by the control separation apparatus 100 of the invention.

With regard to the inputs that the controller 110 receives from the user, the spatial separation apparatus 100 of the invention also an input device 115 that may be positioned inside the vehicle such that the driver may interact with the separation apparatus 100. The input device is generally configured to receive inputs, i.e., through buttons, dials, etc. that represent parameters that the user desires to be inputted or considered by the controller 110. These inputs may be used by the driver of the vehicle to control the operation of the apparatus 100. Notwithstanding the input device, the controller 110 may also receive inputs from one of a plurality of sensors 116. These sensors 116 may include road condition sensors, atmospheric condition sensors, braking ability or condition sensors, daylight sensors, etc. The controller may also receive inputs from VSID devices mounted in other vehicles as well as other methods of receiving input data, through, for example, radio, cellular, etc. communication devices that are configured for communication between devices in proximate vehicles.

The present invention also includes a display device 120 (mentioned above) generally configured to convey information from the vehicle having the invention installed thereon (Vehicle A in FIG. 1) to vehicles that are near or surrounding the vehicle having the invention installed thereon. The display device 120 may generally comprise a plurality of LED's or other light emitting devices that are in communication with the controller 110 and that are configured to generate a visible warning to the driver of a vehicle that is proximate the vehicle having the present invention installed thereon. The display device 120 may also include an audible emitter configured to generate an audible warning. The LED's or other light emitting devices may be of multiple colors, or alternatively, a single device may be configured to emit multiple colors. Additionally, the lights may be configured to emit light at varying intensities.

Returning to FIG. 1, the spatial separation apparatus 100 is mounted on vehicle A and is used to monitor spatial separation between vehicle A and other vehicles B and C. A rearward facing sensor (B) is configured to measure the distance between vehicle A and any vehicle traveling behind vehicle A within the sensor measurement range of the sensors. The rearward facing sensor (B) may be positioned on a rearward facing surface of the vehicle to facilitate these measurements. However, the present invention is not intended to be limited to only rearward facing measurements and warnings. For example, separation between vehicle A and vehicle B is generally referred to as frontal separation. The frontal separation between vehicle A and vehicle B is managed by at least one forward looking sensor that is configured to measure the distance between the front of vehicle A and the back of vehicle B. The forward looking sensor (F) is generally mounted on the front of vehicle A. Side mounted sensors (S) may be mounted on the side of vehicle A so that side measurements and warnings may also be generated for vehicle A.

The spatial separation apparatus 100 may be programmed with a plurality of separation parameters, including a minimum separation parameter. For example, the spatial separation apparatus 100 may be programmed such that when vehicle A is traveling 50 mph, that the minimum rearward separation is 100 ft. In this configuration, when sensor B measures that the rearward separation is 100 ft or less, then the spatial separation apparatus 100 may warn the driver of the vehicle that is coming closer to vehicle A, that the minimum rearward separation distance has been encroached upon. The issued warning, for example, may be a visible yellow light from the display 120. The driver of the proximate car (the vehicle that has encroached upon the minimum safe distance) will see the warning and may then slow down to increase the separation to a safe distance. As the separation distance increases to a level that is outside of the minimum safe distance, then the controller 110 may change the output of the warning/display device 120 to reduce the warning indicator level, e.g., back to a safe indicator, such as a green light or no light at all. Thereafter, the spatial separation apparatus 100 will continue to monitor the separation distance and issue subsequent warnings as the predetermined separation distances are crossed by vehicles. Other exemplary warning modes or configurations may be becoming unsafe (yellow), hazardous (red), or collision imminent (blinking red), for example. Additionally, the intensity of the emitted light may also be varied, i.e. for a modest encroachment a light/medium intensity yellow warning light may be displayed, while for an encroachment where a collision is likely, then a high intensity blinking warning light may be generated.

Thereafter, the spatial separation apparatus 100 will continue to monitor the separation distance and issue subsequent warnings as the predetermined separation distances are crossed by vehicles.

Embodiments of the invention may also include a dash mounted unit containing a visual LED display with, for example, 20 lights (7 green, 6 yellow, 7 red). The dash mounted display may also provide one or more buttons used by the driver to select driving conditions (dry, wet, icy, etc.). A manual on/off switch and rheostat allows driver to turn on/off the apparatus of the invention as well as select brightness of the LED display. A remotely mounted processing unit (such as controller 110) may be employed to house the CPU and power control unless it is integrated into the dash unit.

The display 120 is the key component to the system of the present invention, as this component signals proximate drivers about safe following distances. Although the display 120 is generally described herein as being rearward facing, embodiments of the invention are not limited to this configuration. More particularly, the inventors contemplate that the sensors and display 120 may be used to monitor and alert drivers as to not only rearward spacing, but also as to side and/or front spacing from the vehicle. Further, the display is configured to warn drivers that are close to the subject vehicle in stages, e.g., when a vehicle encroaches upon a broad perimeter or safe distance, then a first-stage warning may be displayed, whereas when a vehicle encroaches on a second perimeter of safe distance, then a second-stage warning may be displayed. The various stages of warnings may correspond with parameters such as the intensity/brightness of the warning, or a flashing rate of the warning, etc.

In one embodiment of the invention, the display 120 may be integrated into a center tail light assembly of the vehicle. Alternatively, the display 120 may be installed as a stand alone unit that attaches to the vehicle.

In another embodiment of the invention, the entire invention may be embodied in a single display box that is configured to be attached to a car so that drivers following or generally behind the subject vehicle may view the display box. In this embodiment, the controller, sensors, and warning devices are all in a unitary package. This allows for ease in installation, and as such, provides a good aftermarket product appeal.

As for programming of the controller 110 or the control program that runs the controller 110 and the apparatus of the invention, generally an assembly program may be used to execute the functions of the apparatus of the invention. However, the invention is not intended to be limited to any particular programming language, as other languages and protocols may be used with equal effectiveness. In operation, generally, every 1/100 second the sensor (the DRS) provides relative speed and distance measurements (representative of the distance a following vehicle is from the subject vehicle) to the controller 110. In most embodiments of the invention, the sensor will take measurements and send them to the controller for processing and determining if the measured distance is within one of the safety zones between about 200 times per second and about 1000 times per second, for example. The vehicles standard equipment speedometer may be used to provide the current speed of the subject vehicle to the controller 110. As this data is received by the controller 110, a calculation is made based upon one of three variables describing operator selected driving conditions (dry, wet, icy). The result illuminates the in car (dash) and/or rear LED displays 120 notifying both drivers (of the subject vehicle and the vehicle following the subject vehicle) of the current following-distance-separation-condition or status. The display may illuminate green, yellow, red, or blinking red in accordance with the determined status of the separation. If the optional audible device is installed the system may sound a warning tone if an imminent collision is predicted. In another embodiment of the invention, transmitted encrypted broadcast signals provide vehicle and other data pertinent to programming options to determine safe driving and stopping distances. This data may also be used for vehicle identification purposes especially military vehicles operating in foreign zones.

Embodiments of the invention also provide several programming options. For example: Imminent Collision Tone—An imminent collision warning tone can be added to provide warning of a rear end collision; Incoming Projectile—Military applications include broader rear scan to provide warning of an incoming ballistic projectile (devices traveling towards the vehicle in excess of 120 mph); and Tri-pod mount—A tripod mounted unit may be programmed to provide roadside workers an audible signal when the projected path of a closing vehicle intercepts their work zone.

While the foregoing is directed to various exemplary embodiments of the present invention, other and further embodiments of the invention may be devised without departing from the basic scope thereof, and the scope thereof is determined by the claims that follow.

1. A vehicle separation warning device, comprising:
a distance measuring sensor positioned on a rearward facing surface of a first vehicle, the distance measuring sensor being configured to measure a distance between the first vehicle and a second vehicle following the first vehicle;
a microprocessor controller in electrical communication with the distance measuring sensor and being configured receive input from the distance measuring sensor and generate outputs therefrom; and
a visual warning device positioned on the first vehicle and being in electrical communication with the microprocessor controller,
wherein the controller is configured execute a program configured to conduct a method comprising;
a) receiving a distance measurement in the controller from the distance measuring sensor, wherein the distance measurement is representative of the distance from the rear of the first vehicle to the front of the second vehicle;
b) determining if the distance measurement is within one of a plurality of predetermined safety zone thresholds; and
c) illuminating the visual warning device in accordance with the determined predetermined safety zone thresholds.

2. The vehicle separation warning device of claim 1, wherein the distance measuring sensor comprises a Doppler radar distance sensor.

3. The vehicle separation warning device of claim 2, wherein the visual warning device comprises a plurality of light emitting diodes (LEDs) positioned in a panel facing rearward from the first vehicle.

4. The vehicle separation warning device of claim 3, wherein steps (a) and (b) are continually repeated until a distance measurement within a safety zone threshold is determined.

5. The vehicle separation warning device of claim 4, wherein steps (a) and (b) are repeated at a rate of between about 200 and about 1000 times per second.

6. The vehicle separation warning device of claim 5, wherein illuminating the visual warning device in accordance with the determined predetermined safety zone thresholds comprises illuminating green for a safe threshold, illuminating yellow for a becoming unsafe threshold, illuminating red for a hazardous safe threshold, or illuminating blinking red for a collision imminent safe condition.

7. The vehicle separation warning device of claim 6, wherein the program is written in assembly language.

8. A method for warning vehicles of unsafe following distances, comprising:
measuring a distance from a first vehicle to a second vehicle with a distance sensor positioned on a rearwardly facing surface of the first vehicle;
transmitting the measured distance to a microprocessor controller positioned in the first vehicle;
comparing, with the controller, the measured distance to stored safe zone distances to determine if the distance corresponds to a predetermined safe zone; and
illuminating a visual display panel positioned on the rearwardly facing surface of the first vehicle in a manner corresponding to the determined predetermined safe zone.

9. The method of claim 8, wherein measuring comprises using a Doppler radar distance measuring device.

10. The method of claim 9, wherein comparing comprises using a microprocessor based controller.

11. The method of claim 10, wherein illuminating comprises:
illuminating green LEDs if a safe safety zone is determined;
illuminating yellow LEDs if a becoming unsafe zone is determined;
illuminating red LEDS if a hazardous zone is determined; and
illuminating blinking red LEDs if a collision imminent zone is determined.

12. The method of claim 10, wherein a control program for the microprocessor controller comprises an assembly language program.

13. The method of claim 10, wherein the measuring, transmitting, and comparing steps are repeated at a rate of between about 200 and about 1000 times per second.

14. The method of claim 13, wherein the distance measuring further comprises measuring a side distance separation or a frontal distance separation.

15. A vehicle separation warning device, comprising:
a Doppler distance measuring sensor positioned on a rearward facing surface of a first vehicle, the Doppler distance measuring sensor being configured to measure a distance between the first vehicle and a second vehicle following the first vehicle;
a microprocessor controller in electrical communication with the distance measuring sensor and being configured receive input from the distance measuring sensor and generate outputs therefrom in accordance with an assembly language program; and
a visual warning device positioned on the first vehicle and being in electrical communication with the microprocessor controller, the visual warning device including a plurality of multiple color LEDs,
wherein the controller is configured execute a program configured to conduct a method comprising;
a) receiving a distance measurement in the controller from the Doppler distance measuring sensor, wherein the distance measurement is representative of the distance from the rear of the first vehicle to the front of the second vehicle;
b) determining if the distance measurement is within one of a plurality of predetermined safety zone thresholds;
c) illuminating a particular color LED on the visual warning device in accordance with the determined predetermined safety zone thresholds; and
d) repeating steps (a)-(c) between about 200 and about 1000 times per second.

16. The vehicle separation warning device of claim 15, wherein the visual warning device further comprises an audible warning device.

17. The vehicle separation warning device of claim 15, wherein illuminating a particular color LED in the visual warning device comprises:
illuminating green LEDs if a safe safety zone is determined;
illuminating yellow LEDs if a becoming unsafe zone is determined;
illuminating red LEDS if a hazardous zone is determined; and
illuminating blinking red LEDs if a collision imminent zone is determined.
